(19) United States
(12) Patent Application Publication
(10) Pub. No.: US 2004/0224230 A1
(43) Pub. Date: Nov. 11, 2004

(54) Lithium cell

(76) Inventors: Katsunori Yanagida, San Diego, CA (US); Atsushi Yanai, Kobe-city (JP); Yoshinori Kida, Kobe-city (JP); Takaaki Ikemachi, Kobe-city (JP); Toshiyuki Nohma, Kobe-city (JP); Takeshi Ogasawara, Scotland (GB)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/795,454

(22) Filed: Mar. 9, 2004

(30) Foreign Application Priority Data
Mar. 10, 2003 (JP) 2003-62602
Aug. 8, 2003 (JP) 2003-206621
Jan. 29, 2004 (JP) 2004-021014

(51) Int. Cl. H01M 4/58; H01M 10/40

(52) U.S. Cl. 429/231.8; 429/330; 429/331

(57) ABSTRACT

A lithium cell includes a positive electrode, a negative electrode employing a carbon material as an active material, and a non-aqueous electrolyte including a solute dissolved in a non-aqueous solvent, and is characterized in that the carbon material in the negative electrode has an R_{A} value (I_{A}/I_{G}) of 0.05 or more, the R_{A} value calculated from a peak intensity (I_{A}) of a broad peak P_{A} having a full width at half maximum of 100 cm⁻¹ or more and a peak intensity (I_{G}) in the vicinity of 1580 cm⁻¹ as determined by laser Raman spectroscopy using an argon ion laser having a wavelength of 514.5 nm, the peak intensity (I_{A}) determined from a peak P_{D} in the vicinity of 1360 cm⁻¹, as determined by the aforesaid laser Raman spectroscopy, which is separated into the broad peak P_{A} having the full width at half maximum of 100 cm⁻¹ or more and a peak P_{B} having a full width at half maximum of less than 100 cm⁻¹.

### BACKGROUND OF THE INVENTION

1. Field of the Invention

The present invention relates to a lithium cell including a positive electrode, a negative electrode employing a carbon material as an active material, and a non-aqueous electrolyte including a solute dissolved in a non-aqueous solvent. More particularly, the invention relates to a lithium cell featuring excellent charge/discharge performances achieved by the use of a suitable carbon material in the negative electrode.

2. Description of the Related Art

As a novel cell of high output and high energy density, a lithium cell has come into use recently, the cell employing a non-aqueous electrolyte including a solute dissolved in a non-aqueous solvent and achieving a high electromotive force based on oxidization and reduction of lithium.

In such a lithium cell, a carbon material, such as graphite and coke, is used as a material for use in the negative electrode, the carbon material permitting the insertion or de-insertion of lithium ions. Particularly, a graphite-based carbon material is widely used for fabricating a lithium cell having a high energy density.

More recently, the use of the following graphite-based carbon material has been proposed in order to prevent the following problem. In a case where a charged lithium cell using the graphite-based carbon material in the negative electrode is allowed to store under high temperatures, the cell encounters the production of gases which raise the internal pressure of the cell. The proposed graphite-based material has an R value (I_{D}/I_{G}) of at least 0.15 and a full width at half maximum of less than 25 cm⁻¹ at a peak in the vicinity of 1580 cm⁻¹, as determined by laser Raman spectroscopy using an argon ion laser having a wavelength of 514.5 nm. The R value (I_{D}/I_{G}) represents the ratio of a peak intensity (I_{D}) in the vicinity of 1360 cm⁻¹ versus a peak intensity (I_{G}) in the vicinity of 1580 cm⁻¹ (see, Japanese Unexamined Patent Publication No.7(1993)-235294).

However, there also exists a problem that the lithium cell cannot be fully improved in the charge/discharge performances even though the aforesaid graphite-based carbon material is used in the negative electrode thereof.

In the aforesaid lithium cell, the non-aqueous solvent used in the non-aqueous electrolyte includes, for example, ethylene carbonate, propylene carbonate, butylene carbonate, sulfolane, γ-butylolactone, ethyl methyl carbonate and the like, which may be used alone or in combination of plural types. In general, solvents having high permittivities, such as cyclic carbonate compounds including propylene carbonate, ethylene carbonate and the like, are widely used.

In a case where ethylene carbonate is used as the non-aqueous solvent, it is difficult to use ethylene carbonate alone because of its high freezing point of 36.4° C. Hence, it is a common practice to use ethylene carbonate as a mixture containing 50 volt % or more of a solvent having a low boiling point such as chain carbonic ester.

Where such a great amount of solvent of low boiling point is admixed, however, drawbacks such as a lowered flash point of the non-aqueous electrolyte result. In the recent years when the cell having higher energy density and output is demanded, in particular, it is desired to enhance safety of the cell.

In a case where propylene carbonate is used as the non-aqueous solvent, on the other hand, the following problems occur if a carbon material such as graphite or coke or particularly a graphite-based material is used as the material for the negative electrode. That is, a surface film having excellent mobility of lithium ions is not formed over the carbon material. Hence, lithium ions are not adequately inserted into or de-inserted from the carbon material. Furthermore, a side reaction occurs on the surface of the negative electrode to decompose propylene carbonate during the charging process, thus interfering with the charge or discharge of the cell.

More recently, there has been proposed an alternative lithium cell improved in the safety, charge/discharge efficiency, and cycle performance and storage performance under high temperature conditions (see, Japanese Unexamined Patent Publication No.2001-297794). Specifically, a vinylene carbonate compound is admixed to a non-aqueous solvent containing 90 wt % or more of at least one solvent having a specific permittivity of 25 or more and selected from the group consisting of ethylene carbonate, propylene carbonate, γ-butylolactone and the like, and having a flash point of 70° C. or more.

In the case where the vinylene carbonate compound is admixed to the aforesaid non-aqueous solvent, however, there still exists a problem that the lithium cell cannot be fully improved in the charge/discharge performances.

### SUMMARY OF THE INVENTION

The invention has an object to solve the aforementioned problems encountered by the lithium cell including the positive electrode, the negative electrode employing the carbon material as the active material, and the non-aqueous electrolyte including the solute dissolved in the non-aqueous solvent.

Specifically, the invention has the object to improve the aforesaid lithium cell to achieve the excellent charge/discharge performances by using a suitable carbon material in the negative electrode. In particular, the invention has the object to fully improve the charge/discharge performances of the lithium cell even in the case where propylene carbonate is used as the non-aqueous solvent in the non-aqueous electrolyte.

According to a first aspect of the invention for achieving the above object, a lithium cell comprises a positive electrode, a negative electrode employing a carbon material as an active material, and a non-aqueous electrolyte comprising a solute dissolved in a non-aqueous solvent, and is characterized in that the negative electrode employs a carbon material having a R_{A} value (I_{A}/I_{G}) of 0.05 or more, the R_{A} value calculated from a peak intensity (I_{A}) of a broad peak P_{A} having a full width at half maximum of 100 cm⁻¹ or more and a peak intensity (I_{G}) in the vicinity of 1580 cm⁻¹ as determined by laser Raman spectroscopy using an argon ion laser having a wavelength of 514.5 nm, the peak intensity (I_{A}) determined from a peak P_{D} in the vicinity of 1360 cm⁻¹, as determined by the laser Raman spectroscopy, which is separated into the broad peak P_{A} having the full width at half maximum of 100 cm⁻¹ or more and a peak P_{B} having a full width at half maximum of less than 100 cm⁻¹.

It is noted here that the peak P_{G} in the vicinity of 1580 cm⁻¹ determined by the laser Raman spectroscopy using the argon ion laser having the wavelength of 514.5 nm is a peak associated with a stacking structure having a hexagonal symmetry resemblant to a graphite structure. In contrast, the peak P_{D} in the vicinity of 1360 cm⁻¹ is a peak associated with an amorphous structure of disturbed crystalline structure of the carbon material.

In the case where the aforesaid peak P_{D i}n the vicinity of 1360 cm⁻¹ is separated into the broad peak PA having the full width at half maximum of 100 cm⁻¹ or more and the peak P_{B} having the full width at half maximum of less than 100 cm⁻¹, the broad peak P_{A} having the full width at half maximum of 100 cm⁻¹ or more is thought to be the peak associated with the amorphous carbon. On the other hand, the peak P_{B} having the full width at half maximum of less than 100 cm⁻¹ is thought to be the peak associated with carbon wherein the graphite structure is disturbed. Incidentally, the broad peak P_{A} having the full width at half maximum of at least 100 cm⁻¹ is determined based on Gaussian function whereas the peak P_{B} having the full width at half maximum of less than 100 cm⁻¹ is determined based on Lorentzian function. Normally, the broad peak P_{A} having the full width at half maximum of 100 cm⁻¹ or more exists in the vicinity of 1380 cm⁻¹ whereas the peak P_{B} having the full width at half maximum of less than 100 cm⁻¹ exists in the vicinity of 1350 cm⁻¹.

The aforesaid R_{A} value (I_{A}/I_{G}) calculated from the peak intensity (I_{G}) in the vicinity of 1580 cm⁻¹ and the peak intensity (I_{A}) of the broad peak P_{A} having the full width at half maximum of 100 cm⁻¹ or more indicates a proportion of the amorphous carbon present in a surface layer of the carbon material.

Where the carbon material having the aforesaid RA value (I_{A}/I_{G}) of 0.05 or more is used as the carbon material in the negative electrode, as suggested by the lithium cell of the first aspect of the invention, the non-aqueous electrolyte forms a surface film over the carbon material, the surface film having an excellent mobility of lithium ions. This results in the suppression of the decomposition of the non-aqueous electrolyte which may occur at an interface between the negative electrode and the non-aqueous electrolyte. In the meantime, lithium ions are adequately inserted into or de-inserted from the above carbon material so that the lithium cell can achieve the excellent charge/discharge performances. If the aforesaid R_{A} value (I_{A}/I_{G}) is too great, the amorphous carbon is present in the surface layer over the carbon material in an excessive proportion. This results in problems such as lowered charge/discharge performances of the lithium cell. Hence, it is preferred to use a carbon material having an R_{A} value (I_{A}/I_{G}) in the range of 0.05 to 0.40, more preferably a carbon material having an R_{A} value (I_{A}/I_{G}) in the range of 0.05 to 0.25 or still more preferably a carbon material having an R_{A} value (I_{A}/I_{G}) in the range of 0.10 to 0.25.

According to the lithium cell of the first aspect of the invention, if vinylene carbonate is admixed to the above non-aqueous electrolyte, the vinylene carbonate contributes to the formation of a more consistent and compact surface film over the aforesaid carbon material, the surface film having the excellent mobility of lithium ions. This leads to a more positive suppression of the decomposition of the non-aqueous electrolyte which may occur at the interface between the negative electrode and the non-aqueous electrolyte. Hence, lithium ions are inserted into or de-inserted from the above carbon material in a more suitable manner so that the lithium cell can achieve the excellent charge/discharge performances.

In a case where a non-aqueous solvent containing propylene carbonate is used in the non-aqueous electrolyte, further addition of vinyl ethylene carbonate to the non-aqueous electrolyte offers the following effect. The added vinyl ethylene carbonate contributes to the formation of a more consistent and compact surface film over the above carbon material, the surface film having the excellent mobility of lithium ions. The surface film more positively suppresses the decomposition of the propylene carbonate and also promotes the insertion/de-insertion of lithium ions into/from the above carbon material even futher. Thus, the lithium cell can achieve the excellent charge/discharge performances. If vinylene carbonate is still further admixed to the non-aqueous electrolyte, the added vinylene carbonate contributes to the formation of a still more consistent and compact surface film over the aforesaid carbon material, the surface film having the excellent mobility of lithium ions. Hence, the non-aqueous electrolyte is still more positively prevented from being decomposed at the interface between the negative electrode and the non-aqueous electrolyte. Furthermore, lithium ions are inserted into or de-inserted from the above carbon material in a still more suitable manner. Thus, the lithium cell can achieve the excellent charge/discharge performances.

According to a second aspect of the invention, a lithium cell comprises a positive electrode, a negative electrode employing a carbon material as an active material, and a non-aqueous electrolyte comprising a solute dissolved in a non-aqueous solvent containing 60 vol % or more of propylene carbonate, and is characterized in that the carbon material in the negative electrode comprises a carbon material having an R value (I_{D}/I_{G) of} 0.20 or more, the R value calculated from a peak intensity (I_{G}) in the vicinity of 1580 cm⁻¹ and a peak intensity (I_{D}) in the vicinity of 1360 cm⁻¹, as determined by laser Raman spectroscopy using an argon ion laser having a wavelength of 514.5 nm, and that vinyl ethylene carbonate as an additive is admixed to the non-aqueous electrolyte.

It is noted here that the peak in the vicinity of 1580 cm⁻¹ is the peak associated with the stacking structure having the hexagonal symmetry resemblant to the graphite structure. On the other hand, the peak in the vicinity of 1360 cm⁻¹ is the peak associated with the amorphous structure of disturbed crystalline structure of the carbon material. The greater the proportion of the amorphous portion in the surface layer of the carbon material, the greater the R value (I_{D}/I_{G}).

Where, as suggested by the lithium cell of the second aspect of the invention, vinyl ethylene carbonate as the additive is admixed to the non-aqueous electrolyte comprising the solute dissolved in the non-aqueous solvent containing 60 vol % or more of propylene carbonate while the negative electrode employs the carbon material having the aforesaid R value (I_{D}/I_{G}) of 0.20 or more or reduced in crystallinity at the surface thereof, vinyl ethylene carbonate admixed to the non-aqueous electrolyte forms a consistent and compact surface film over the carbon material, the surface film having high mobility of lithium ions. This leads to the suppression of the decomposition of propylene carbonate which may occur at the interface between the negative electrode and the non-aqueous electrolyte. Incidentally, if the R value (I_{D}/I_{G}) is too great, the amorphous portion at the surface of the carbon material is increased so much that problems such as the lowered charge/discharge performances of the cell are encountered. Therefore, it is preferred to use a carbon material having the aforesaid R value (I_{D}/I_{G}) in the range of 0.20 to 1.0, or more preferably of 0.20 to 0.60.

According to the lithium cell of the second aspect of the invention, as well, the use of the carbon material having the R_{A} value (I_{A}/I_{G}) in the range of 0.05 to 0.25 is advantageous in that vinyl ethylene carbonate admixed to the non-aqueous electrolyte forms over this carbon material a more consistent and compact surface film having high mobility of lithium ions. This leads to a still more positive suppression of the decomposition of propylene carbonate which may occur at the interface between the negative electrode and the non-aqueous electrolyte. It is more preferred to use a carbon material having the aforesaid R_{A} value (I_{A}/I_{G}) in the range of 0.10 to 0.25.

From the standpoint of imparting the lithium cells of the first and second aspects of the invention with a high discharge capacity, it is desirable to use a graphite-based material as the aforesaid carbon material. A preferred material may have a spacing d₀₀₂ of 002 lattice planes in the range of 0.335 to 0.338 nm and a length Lc of a crystallite in the C-axis direction in the range of 30 nm or more, as determined by X-ray diffraction analysis. A still more preferred material may have a spacing d₀₀₂ in the range of 0.335 to 0.336 nm and an Lc value of 110 nm or more.

In order to obtain a lithium cell excellent in the discharge performance at high rate, it is preferred to use a carbon material having a ratio (I₁₁₀/I002) in the range of 5×10⁻³ to 1.5×10⁻², the ratio between a peak intensity I₀₀₂ at 002 plane and a peak intensity I₁₁₀ at 110 plane, as determined by X-ray diffraction analysis.

The carbon material having the R_{A} value (I_{A}/I_{G}) of 0.05 or more or the R value (I_{D}/I_{G}) of 0.20 or more, as describe above, may be prepared as follows. Graphite or such having high crystallinity is used as a first carbon material. A part or the all of the surface of the first carbon material, as a core, is coated with a second carbon material having a lower crystallinity than that of the first carbon material. The resultant carbon material is adapted for proper control of the crystallinity of the surface thereof, so that a lithium cell excellent in the discharge performance may be obtained.

Where a part or the all of the surface of the first carbon material, as the core, having the higher crystallinity is coated with the second carbon material having the lower crystallinity, it may be contemplated as a usable method to carbonize a mixture including the first carbon material, as the core, and a carbonizable organic compound, or to form the coating film by CVD process or the like. Specifically, the carbon material of this composition is prepared by the steps of: immersing the first carbon material, as the core, in pitch, tar or a solution prepared by dissolving a phenol formaldehyde resin, furfuryl alcohol resin, carbon black, vinylidene chloride, cellulose or the like in an organic solvent such as methanol, ethanol, benzene, acetone and toluene; and then carbonizing the resultant carbon material in an inert atmosphere at temperatures ranging from 500° C. to 1800° C., or preferably from 700° C. to 1400° C.

According to the lithium cell of the above first aspect of the invention, the type of the non-aqueous solvent used in the non-aqueous electrolyte is not particularly limited. However, it is preferred to use the non-aqueous solvent in the form of a solvent mixture including a cyclic carbonate such as ethylene carbonate, propylene carbonate or butylene carbonate, or a cyclic ester such as T-butylolactone. Particularly preferred is a solvent mixture including ethylene carbonate or γ-butylolactone.

According to the lithium cell of the second aspect of the invention, on the other hand, the non-aqueous solvent used in the non-aqueous electrolyte is prepared by dissolving a solute in the non-aqueous solvent containing 60 vol % or more of propylene carbonate, as described above. The propylene carbonate may preferably be admixed with a non-aqueous solvent comprising a cyclic carbonate such as ethylene carbonate or butylene carbonate, or a cyclic ester such as r-butylolactone. It is particularly preferred to admix ethylene carbonate or γ-butylolactone.

According to the lithium cells of the first and second aspects of the invention, any of the other non-aqueous solvents commonly used in the lithium cell may be admixed in addition to the aforementioned non-aqueous solvent. Examples of a usable non-aqueous solvent include: carbonates such as dimethyl carbonate, ethyl methyl carbonate, diethyl carbonate, methyl propyl carbonate, and ethyl propyl carbonate; esters such as methyl acetate, ethyl acetate, propyl acetate and ethyl propionate; ethers such as tetrahydrofuran, 2-methyltetrahydrofuran, 1,4-dioxane, 1,2-dimethoxyethane, and 1,2-diethoxyethane; nitriles such as acetonitrile; and amides such as dimethylformamide.

As to the solute used in the aforesaid non-aqueous electrolyte, any of solutes commonly used in the lithium cells may be used. Examples of a usable solute include LiPF₆, LiAsF₆, LiBF₄, LiCF₃SO₃, LiN(CₗF₂ₗ₊ₗSO₂)(CₘF₂ₘ₊₁SO₂) (1, m each denoting an integer of at least 1), LiC(CₚF₂ₚ₊ₗSO₂)(C_{q}F_{2q+1}SO₂)(CᵣF₂ᵣ₊₁SO₂) (p, q, r each denoting an integer of at least 1) and the like. These solutes may be used alone or in combination of plural types. Likewise to the conventional non-aqueous electrolyte, the non-aqueous electrolyte of the invention may also contain the solute in concentrations of 0.1 to 1.5 mol/l, or preferably of 0.5 to 1.5 mol/l.

Where vinyl ethylene carbonate, as the additive, is admixed to the non-aqueous electrolyte of the lithium cell of the first or second aspect of the invention, as described above, attention should be paid to the following points. If vinyl ethylene carbonate is added in an insufficient amount, the surface film having high mobility of lithium ions is less prone to be formed over the above carbon material. Conversely if vinyl ethylene carbonate is added in an excessive amount, a thick surface film is formed over the carbon material so that the lithium cell suffers a lowered discharge performance because of an increased reaction resistance. Therefore, it is preferred to add vinyl ethylene carbonate in an amount of 0.1 to 10 parts by weight based on 100 parts by weight of non-aqueous electrolyte.

It is further preferred that the aforesaid non-aqueous electrolyte further contains, as additives, a cyclic carbonate compound having carbon-to-carbon double bonds in addition to the aforesaid vinyl ethylene carbonate. Examples of such a cyclic carbonate compound having carbon-to-carbon double bonds include vinylene carbonate, 4,5-dimethylvinylene carbonate, 4,5-diethylvinylene carbonate, 4,5-dipropylvinylene carbonate, 4-ethyl-5-methylvinylene carbonate, 4-ethyl-5-propylvinylene carbonate, 4-methyl-5-propylvinylene carbonate and the like. In a case where vinylene carbonate is admixed to the non-aqueous electrolyte, in particular, a surface film having mobility of lithium ions and stable to charge/discharge processes may be formed over the carbon material. Thus, a lithium cell excellent in charge/discharge cycle performance may be obtained.

Where vinyl ethylene carbonate and vinylene carbonate as an additive mixture is admixed to the non-aqueous electrolyte, attention should be paid to the following point. If the additive mixture is added in an excessive amount, the surface film formed over the carbon material is so thick that the lithium cell is lowered in the discharge capacity or charge/discharge efficiency. It is therefore preferred to use the additive mixture including vinyl ethylene carbonate and vinylene carbonate in an amount of 0.1 to 13 parts by weight based on 100 parts by weight of non-aqueous electrolyte.

From the view point of improving the non-aqueous electrolyte in wetting performance to a separator, the non-aqueous electrolyte may preferably be admixed with a surfactant such as trioctyl phosphate.

According to the lithium cells of the first and second aspects of the invention, a material for use in the positive electrode is not particularly limited and any of the positive-electrode materials commonly used in the art may be used. Examples of a usable positive-electrode material include lithium-containing transition metal oxides such as lithium cobalt oxide LiCoO₂, lithium nickel oxide LiNiO₂ and lithium manganese oxide LiMn₂O₄.

In a case where the lithium cell of the first or second aspect of the invention is fabricated using propylene carbonate as the non-aqueous solvent, attention should be paid to the following point. If an initial charging of the lithium cell is performed at a high current, propylene carbonate is decomposed before the surface film having mobility of lithium ions is formed over the carbon material. Hence, the cell is lowered in the discharge performance. It is therefore preferred to perform the initial charging process at a current value of 5 hour rate (0.2 It) or less. The subsequent charging processes may be performed at a current density of more than 5 hour rate (0.2 It).

These and other objects, advantages and features of the invention will become apparent from the following description thereof taken in conjunction with the accompanying drawings which illustrate specific embodiments of the invention.

### BRIEF DESCRIPTION OF THE DRAWING

FIG. 1 is a sectional view illustrating an internal structure of a test cell fabricated in examples and comparative examples of the invention.

### DESCRIPTION OF THE PREFERRED EMBODIMENTS

A lithium cell according to the invention will be specifically described by way of examples thereof. Additionally, comparative examples will be cited to demonstrate that the lithium cell according to the invention is improved in the charge capacity and charge/discharge efficiency. It is to be noted that the lithium cell according to the invention is not limited to the following examples thereof but may be practiced in modifications as requierd so long as such modifications do not deviated from the scope of the invention.

### EXAMPLE 1

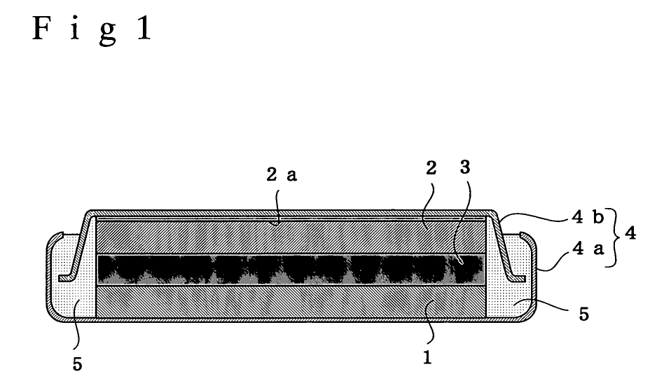

In Example 1, a flat coin-type test cell was fabricated. As shown in FIG. 1, the test cell had a diameter of 24.0 mm and a thickness of 3.0 mm.

In the test cell, a working electrode constituting a negative electrode was fabricated using the following carbon material prepared as follows. Graphite particles (d₀₀₂=0.336 nm, Lc>100 nm) were coated with pitch by immersing the graphite particles in a molten pitch followed by drying. The graphite particles thus coated with the pitch were carbonized in a nitrogen atmosphere at 1100° C. for 2 hours. Thus was obtained a carbon material including the above graphite particles coated with carbon having a low crystallinity. In Example 1, the graphite particles were coated with the pitch in a manner to provide 8 parts by weight of pitch coating based on 100 parts by weight of graphite particles.

The above carbon material was subjected to a Raman spectrometer (T-64000 commercially available from HORIBA LTD.) which irradiated argon ion laser having a wavelength of 514.5 nm on the carbon material so as to observe Raman spectroscopy thereof for determination of a peak intensity (I_{G}) in the vicinity of 1580cm⁻¹ and a peak intensity (I_{D}) in the vicinity of 1360cm⁻¹. The measurement results gave the aforesaid R value (I_{D}/I_{G}) at 0.40.

The aforesaid peak P_{D} in the vicinity of 1360cm⁻¹ was separated into a broad peak P_{A} having a full width at half maximum of at least 100cm⁻¹ and a peak P_{B} having a full width at half maximum of less than 100cm⁻¹ so as to determine a peak intensity (I_{A}) of the broad peak P_{A} having the full width at half maximum of at least 100cm⁻¹. A peak position of the broad peak P_{A} having the full width at half maximum of at least 100cm⁻¹ as determined based on Gaussian function was at 1380cm⁻¹ whereas the peak P_{B} having the full width at half maximum of less than 100cm⁻¹ as determined based on Lorentzian function was at 1350cm⁻¹.

There was calculated the R_{A} value (I_{A}/I_{G}) of a ratio of the peak intensity (I_{A}) of the broad peak P_{A} having the full width at half maximum of at least 100cm⁻¹ versus the peak intensity (I_{G}) in the vicinity of 1580cm⁻¹. The above material had an R_{A} value (I_{A}/I_{G}) of 0.16.

In the above carbon material, a ratio (I₁₁₀/I₀₀₂) of a peak intensity I₁₁₀ at 110 plane versus a peak intensity I₀₀₂ at 002 plane was at 1.1×⁻² as determined by X-ray diffraction analysis.

Then, 97.5 parts by weight of the carbon material, 1 part by weight of styrene-butadiene rubber, and 1.5 parts by weight of carboxymethylcellulose were blended together. Water was added to the resultant mixture to form a slurry, which was applied to one side of a current collector formed of a copper foil. The slurry on the foil piece was dried, pressure spread and cut into a disk shape having a diameter of 20 mm. Thus was fabricated the working electrode constituting the negative electrode.

The test cell employed a counter electrode which was formed by cutting a lithium sheet into a disk shape having a diameter of 20 mm, the lithium sheet pressure spread to a predetermined thickness. 1There was used a non-aqueous electrolyte which was prepared by dissolving lithium hexafluorophosphate LiPF₆, as a solute, in a non-aqueous solvent mixture in a concentration of 1.0 mol/l, the solvent mixture containing propylene carbonate and ethylene carbonate in a volume ratio of 70:30. Then, 5 parts by weight of vinyl ethylene carbonate (VEC), 2 parts by weight of vinylene carbonate (VC) and 2 parts by weight of trioctyl phosphate as a surfactant were admixed to 100 parts by weight of the non-aqueous electrolyte. As indicated by Table 1 as below, the respective amounts of vinyl ethylene carbonate (VEC) and vinylene carbonate (VC) based on the non-aqueous electrolyte were 5 wt % and 2 wt %.

The test cell was fabricated as follows. A separator 3 formed from a polyethylene porous film was immersed in the non-aqueous electrolyte admixed with the aforementioned additives. As shown in FIG. 1, the separator 3 was inserted between a counter electrode 1 constituting a positive electrode and a working electrode 2 constituting a negative electrode. The counter electrode and working electrode with the separator inserted therebetween are accommodated in a cell case 4 in a manner that a current collector 2a for the working electrode 2 is held in contact with a bottom 4a of the cell case 4 while the counter electrode 1 is held in contact with a cover 4b of the cell case 4. The bottom 4a and cover 4b were electrically isolated from each other by means of an insulating packing 5.

### EXAMPLES 2-6 AND COMPARATIVE EXAMPLES 1, 2

In Examples 2-6 and Comparative Examples 1, 2, the same procedure as in Example 1 was taken to fabricate individual test cells, except that the amounts of vinyl ethylene carbonate (VEC) and vinylene carbonate (VC) added to the non-aqueous electrolyte were varied.

As shown in the following Table 1, Example 2 added 10 wt % of vinyl ethylene carbonate (VEC) and 2 wt % of vinylene carbonate (VC) to the above non-aqueous electrolyte; Example 3 added 5 wt % of vinyl ethylene carbonate (VEC) and 4 wt % of vinylene carbonate (VC); Example 4 added 10 wt % of vinyl ethylene carbonate (VEC) and 4 wt % of vinylene carbonate (VC); Example 5 added 5 wt % of vinyl ethylene carbonate (VEC) but added no vinylene carbonate (VC); Example 6 added 10 wt % of vinyl ethylene carbonate (VEC) but added no vinylene carbonate (VC);. Comparative Example 1 added 2 wt % of vinylene carbonate (VC) but added no vinyl ethylene carbonate (VEC); and Comparative Example 2 added 4 wt % of vinylene carbonate (VC) but added no vinyl ethylene carbonate (VEC).

Each of the test cells of Examples 1-6 and Comparative Examples 1, 2 was subjected to lithium-ion insertion as follows. A current at a density of 0.5 mA/cm² was used to insert lithium ions from the counter electrode into the carbon material used in the working electrode until the voltage of the working electrode was at 0.0V versus the counter electrode. Next, a current at a density of 0.25 mA/cm² was used to insert lithium ions from the counter electrode into the carbon material used in the working electrode until the voltage of the working electrode was at 0.0V versus the counter electrode. Further, a current at a density of 0.1 mA/cm² was used to insert lithium ions from the counter electrode into the carbon material used in the working electrode until the voltage of the working electrode was at 0.0V versus the counter electrode.

As to the case where lithium ions were inserted into the carbon material in the working electrode of each of the test cells, as described above, the carbon material in each test cell was determined for capacity Q1 (mAh/g). The results are listed in the following Table 1.

Subsequently, the carbon material in each of the above test cells was subjected to lithium-ion de-insertion as follows. A constant current at a current density of 0.25 mA/cm² was used to de-insert the lithium ions from the lithium-inserted carbon material until the voltage of the working electrode was at 1.0V versus the counter electrode.

As to the case where lithium ions were de-inserted from the carbon material in the working electrode of each of the test cells, as described above, the carbon material in each test cell was determined for capacity Q2 (mAh/g). The results are listed in the following Table 1.

As a lithium-ion charge/discharge efficiency for the carbon material in each of the test cells, there was determined a ratio [(Q2/Q1)×100] of the capacity Q2 versus the capacity Q1. The results are listed in the following Table 1.

The above test cells of Examples 1-6 were each determined for reaction resistance (Ω·cm²) as follows. After the aforementioned de-insertion of lithium ions from the carbon material, the impedance of each cell was measured as superimposing an AC having a frequency of 20 kHz to 10 mHz and an amplitude of 10 mV so as to determine the reaction resistance (Ω·cm²) of each of the test cells of Examples 1-6. The results are listed in the following Table 1.

Each of the test cells of Examples 1-6 was cycled through 10 operation cycles. Each operation cycle included the steps of: effecting conduction at a current density of 0.5 mA/cm² for inserting lithium ions from the counter electrode into the carbon material in the working electrode until the voltage of the working electrode was at 0.0V versus the counter electrode; effecting conduction at a current density of 0.25 mA/cm² for inserting lithium ions from the counter electrode into the carbon material in the working electrode until the voltage of the working electrode was at 0.0V versus the counter electrode; effecting conduction at a current density of 0.1 mA/cm² for inserting lithium ions from the counter electrode into the carbon material in the working electrode until the voltage of the working electrode was at 0.0V versus the counter electrode; and effecting conduction of a constant current at a current density of 0.25 mA/cm² for de-inserting the lithium ions from the lithium-inserted carbon material until the voltage of the working electrode was at 1.0V versus the counter electrode. In the 10th operation cycle, each test cell was determined for a capacity Q3 (mAh/g) of the carbon material from which lithium ions were de-inserted. As a percentage capacity retention for the carbon material used in each of the test cells of Examples 1-6, a ratio [(Q3×Q1)×100] of the capacity Q3 versus the aforesaid capacity Q1 was calculated. The results are listed in the following Table 1.

TABLE 1

| | | | | | CHARGE/ | | PERCENTAGE |
|---|---|---|---|---|---|---|---|
| | | | | | DISCHARGE | REACTION | CAPACITY |
| | VEC | VC | Q1 | Q2 | EFFICIENCY | RESISTANCE | RETENTION |
| | (wt %) | (wt %) | (mAh/g) | (mAh/g) | (%) | (Ω · cm²) | (%) |
| EXAMPLE 1 | 5 | 2 | 383 | 358 | 93.4 | 83 | 92.4 |
| EXAMPLE 2 | 10 | 2 | 384 | 359 | 93.5 | 79 | 95.0 |
| EXAMPLE 3 | 5 | 4 | 387 | 361 | 93.3 | 90 | 97.8 |
| EXAMPLE 4 | 10 | 4 | 384 | 356 | 92.7 | 125 | 95.4 |
| EXAMPLE 5 | 5 | 0 | 385 | 362 | 94.0 | 30 | 89.2 |
| EXAMPLE 6 | 10 | 0 | 387 | 364 | 94.1 | 31 | 91.9 |
| COMPARATIVE | 0 | 2 | 407 | 337 | 82.8 | — | — |
| EXAMPLE 1 | | | | | | | |
| COMPARATIVE | 0 | 4 | 374 | 331 | 88.5 | — | — |
| EXAMPLE 2 | | | | | | | |

As apparent from the results, the test cells of Examples 1-6 each employing the non-aqueous electrolyte admixed with vinyl ethylene carbonate (VEC) have greater capacities Q2 than the test cells of Comparative Examples 1, 2 each employing the non-aqueous electrolyte: free from vinyl ethylene carbonate (VEC), the capacity Q2 permitting the de-insertion of lithium ions from the carbon material. Thus, the test cells of the above examples are significantly improved in the lithium-ion charge/discharge efficiency for the carbon material.

A comparison among the test cells of Examples 1-6 indicates the following facts. If vinylene carbonate (VC) is admixed to the non-aqueous electrolyte in an excessive amount, the carbon material is generally decreased in the capacity Q2 to permit the lithium-ion de-insertion therefrom so that the carbon material suffers a lowered charge/discharge efficiency as well as an increased reaction resistance. In the test cell of Example 4 wherein the total amount of vinyl ethylene carbonate (VEC) and vinylene carbonate (VC) admixed to the non-aqueous electrolyte exceeds 13 wt %, in particular, the carbon material suffered greater decrease in the lithium-ion charge/discharge efficiency and increase in the reaction resistance, as compared with those of the test cells of the other examples.

In the case where vinylene carbonate (VC) in addition to vinyl ethylene carbonate (VEC) are admixed to the non-aqueous electrolyte, the percentage capacity retention is increased and the charge/discharge cycle performance is improved.

### EXAMPLE 7

Example 7 used the same graphite particles (d₀₀₂=0.336 nm, Lc>100 nm) as those of Example 1, which were immersed in the molten pitch and then dried the same way as in Example 1 thereby obtaining a carbon material of the graphite particles coated with the pitch, except that the amount of pitch coating was adjusted to 5 parts by weight based on 100 parts by weight of graphite particles. Subsequently, the resultant carbon material was used to fabricate a working electrode constituting the negative electrode.

The resultant carbon material was determined for the R value (I_{D}/I_{G}) and for the R_{A} value (I_{A}/I_{G}) the same way as in Example 1. The carbon material had an R value (I_{D}/I_{G}) of 0.31 and an R_{A} value (I_{A}/I_{G}) of 0.12 as shown in Table 2 as below.

A test cell of Example 7 was fabricated the same way as in Example 3, except that the above working electrode was used. That is, 5 wt % of vinyl ethylene carbonate (VEC) and 4 wt % of vinylene carbonate (VC) were admixed to the non-aqueous electrolyte prepared in Example 1.

### EXAMPLE 8

Example 8 used a different graphite particles (d₀₀₂=0.336 nm, Lc>80 nm) from those of Example 1 to fabricate a working electrode constituting the negative electrode. The graphite particles were not coated with pitch and used as they were. Except for this, the same procedure as in Example 1 was taken to fabricate the working electrode constituting the negative electrode.

The carbon material was determined for the R value (I_{D}/I_{G}) and for the R_{A} value (I_{A}/I_{G}) the same way as in Example 1. The carbon material had an R value (I_{D}/I_{G}) of 0.32 and an R_{A} value (I_{A}/I_{G}) of 0.00 as shown in Table 2 as below.

A test cell of Example 8 was fabricated the same way as in Example 3, except that the above working electrode was used. That is, 5 wt % of vinyl ethylene carbonate (VEC) and 4 wt % of vinylene carbonate (VC) were admixed to the non-aqueous electrolyte prepared in Example 1.

### EXAMPLE 9

Example 9 used the same graphite particles (d₀₀₂=0.336 nm, Lc>100 nm) as those of Example 1 which were immersed in the molten pitch and then dried the same way as in Example 1 thereby obtaining a carbon material of the graphite particles coated with the pitch, except that the amount of pitch coating was adjusted to 20 parts by weight based on 100 parts by weight of graphite particles. Subsequently, the resultant carbon material was used to fabricate a working electrode constituting the negative electrode.

The resultant carbon material was determined for the R value (I_{D}/I_{G}) and for the R_{A} value (I_{A}/I_{G}) the same way as in Example 1. The carbon material had an R value (I_{D}/I_{G}) of 0.62 and an R_{A} value (I_{A}/I_{G}) of 0.26 as shown in Table 2 as below.

A test cell of Example 9 was fabricated the same way as in Example 3, except that the above working electrode was used. That is, 5 wt % of vinyl ethylene carbonate (VEC) and 4 wt % of vinylene carbonate (VC) were admixed to the non-aqueous electrolyte prepared in Example 1.

### COMPARATIVE EXAMPLE 3

In Comparative Example 3, the same graphite particles (d₀₀₂=0.336 nm, Lc>100 nm) as those of Example 1 were not coated with pitch and used as they were. Except for this, the same procedure as in Example 1 was taken to fabricate a working electrode constituting the negative electrode.

The carbon material was determined for the R value (I_{D}/I_{G}) and for the R_{A} value (I_{A}/I_{G}) the same way as in Example 1. The carbon material had an R value (I_{D}/I_{G}) of 0.18 and an R_{A} value (I_{A}/I_{G}) of 0.00 as shown in Table 2 as below.

A test cell of Comparative Example 3 was fabricated the same way as in Example 3, except that the above working electrode was used. That is, 5 wt % of vinyl ethylene carbonate (VEC) and 4 wr % of vinylene carbonate (VC) were admixed to the non-aqueous electrolyte prepared in Example 1.

Next, the test cells of Examples 7-9 and Comparative Example 3 thus fabricated were each subjected to the lithium-ion insertion the same way as the test cells of Example 1-6. That is, conduction was effected at a current density of 0.5 mA/cm² for inserting lithium ions from the counter electrode into the carbon material in the working electrode until the voltage of the working electrode was at 0.0V versus the counter electrode; conduction was effected at a current density of 0.25 mA/cm² for inserting lithium ions from the counter electrode into the carbon material in the working electrode until the voltage of the working electrode was at 0.0V versus the counter electrode; and then conduction was effected at a current density of 0.1 mA/cm² for inserting lithium ions from the counter electrode into the carbon material in the working electrode until the voltage of the working electrode was at 0.0V versus the counter electrode.

As to the case where lithium ions were inserted into the carbon material in the working electrode of each of the test cells, as described above, the capacity Q1 (mAh/g) of the carbon material in each test cell was determined. The results along with that of the test cell of Example 3 are listed in the following Table 2.

Subsequently, each of the above test cells was subjected to the lithium ion de-insertion as follows. That is, conduction of a constant current at a current density of 0.25 mA/cm² was effected thereby de-inserting the lithium ions from the lithium-inserted carbon material until the voltage of the working electrode was at 1.0V versus the counter electrode.

As to the case where the lithium ions were de-inserted from the carbon material in the working electrode of each test cell, the capacity Q2 (mAh/g) of the carbon material in each test cell was determined. Furthermore, the ratio [(Q2/Q1)×100] of the capacity Q2 versus the capacity Q1 was determined as the lithium-ion charge/discharge efficiency for the carbon material. The results along with that of the test cell of Example 3 are listed in the following Table 2.

After the aforementioned de-insertion of the lithium ions from the carbon material in each test cell, the impedance of each test cell was measured as superimposing an AC having a frequency of 20 kHz to 10 mHz and an amplitude of 10 mV so as to determine the reaction resistance (Ω·cm²) of each test cell. The results along with that of the test cell of Example 3 are listed in the following Table 2.

TABLE 2

| | | | | | COMPARATIVE |
|---|---|---|---|---|---|
| | EXAMPLE 3 | EXAMPLE 7 | EXAMPLE 8 | EXAMPLE 9 | EXAMPLE 3 |
| R VALUE (I_{D}/I_{G}) | 0.40 | 0.31 | 0.32 | 0.62 | 0.18 |
| R_{A} VALUE (I_{A}/I_{G}) | 0.16 | 0.12 | 0.00 | 0.26 | 0.00 |
| VEC (wt %) | 5 | 5 | 5 | 5 | 5 |
| VC (wt %) | 4 | 4 | 4 | 4 | 4 |
| Q1 (mAh/g) | 387 | 381 | 341 | 360 | 381 |
| Q2 (mAh/g) | 361 | 354 | 320 | 335 | 351 |
| CHARGE/DISCHARGE EFFICIENCY | 93.3 | 93.2 | 93.8 | 93.1 | 92.1 |
| (%) | | | | | |
| REACTION RESISTANCE | 90 | 98 | 120 | 150 | 135 |
| (Ω · cm²) | | | | | |

As apparent from the results, the test cells of Examples 3, 7-9 employing the carbon materials having the R values (I_{D}/I_{G}) of 0.20 or more are more improved in the lithium-ion charge/discharge efficiency for the carbon material as compared with the test cell of Comparative Example 3 employing the carbon material having the R value (I_{D}/I_{G}) of less than 0.20, the carbon material used in the negative electrode.

Furthermore, the test cells of Examples 3, 7 employing the carbon materials having the R values (I_{D}/I_{G}) in the range of 0.20 to 0.60 and the R_{A} values (I_{A}/I_{G}) in the range of 0.05 to 0.25 are more improved in the charge/discharge performances with lower reaction resistances, as compared with the test cell of Comparative Example 3, the test cell of Example 9 employing the carbon material having the R value (I_{D}/I_{G}) of more than 0.60 and the R_{A} value (I_{A}/I_{G}) of more than 0.25, and the test cell of Example 8 employing the carbon material having the R_{A} value (I_{A}/I_{G}) of 0.00.

The test cells of Examples 3, 7 have higher values of the aforesaid capacities Q1 and Q2 than the test cells of Example 8, 9. As compared with the test cell of Example 8 employing the carbon material having the R_{A} value (I_{A}/I_{G}) of 0.00, in particular, the test cells of Examples 3, 7 have achieved much greater values of the capacities Q1 and Q2.

### EXAMPLE 10

Likewise to Example 1 described above, Example 10 used the graphite particles having the R value (I_{D}/I_{G}) of 0.40 and the R_{A} value (I_{A}/I_{G}) of 0.16 to fabricate the working electrode constituting the negative electrode.

On the other hand, the non-aqueous electrolyte did not use propylene carbonate as the non-aqueous solvent. An alternative non-aqueous electrolyte was prepared by dissolving lithium hexafluorophosphate LiPF₆, as a solute, in a non-aqueous solvent mixture in a concentration of 1.0 mol/l, the solvent mixture containing ethylene carbonate and ethylmethyl carbonate in a volume ratio of 30:70. Then, vinylene carbonate (VC) was admixed to the non-aqueous electrolyte in an amount of 2 parts by weight based on 100 parts by weight of the non-aqueous electrolyte. Except for this, the same procedure as in Example 1 was taken to fabricate a test cell of Example 10.

### EXAMPLE 11

Example 11 used the same graphite particles as those of Example 7 as the carbon material to fabricate a working electrode constituting the negative electrode, the graphite particles having the R value (I_{D}/I_{G}) of 0.31 and the R_{A} value (I_{A}/I_{G}) of 0.12. Except for this, the same procedure as in Example 10 was taken to fabricate a test cell of Example 11.

### EXAMPLE 12

Example 12 used the same graphite particles as those of Example 9 as the carbon material to fabricate a working electrode constituting the negative electrode, the graphite particles having the R value (I_{D}/I_{G}) of 0.62 and the R_{A} value (I_{A}/I_{G}) of 0.26. Except for this, the same procedure as in Example 10 was taken to fabricate a test cell of Example 12.

### EXAMPLE 13

Example 13 fabricated a working electrode constituting the negative electrode as follows. Graphite particles (d₀₀₂=0.336 nm, Lc>100 nm) were immersed in a molted pitch and then, dried. The graphite particles thus coated with the pitch were calcined in a nitrogen atmosphere at 1000° C. for 2 hours. Thus was obtained a carbon material including the above graphite particles coated with carbon having a low crystallinity. In Example 13, the graphite particles were coated with the pitch in a manner to provide 25 parts by weight of pitch coating based on 100 parts by weight of graphite particles.

The resultant carbon material had an R value (I_{D}/I_{G}) of 0.82 and an R_{A} value (I_{A}/I_{G}) of 0.48.

The carbon material was used to fabricate the working electrode constituting the negative electrode. Except for this, the same procedure as in Example 10 was taken to fabricate a test cell of Example 13.

### COMPARATIVE EXAMPLE 5

Comparative Example 4 used, as the carbon material, the same graphite particles as those used in Comparative Example 3 to fabricate a working electrode constituting the negative electrode, the graphite particles having the R value (I_{D}/I_{G}) of 0.18 and the R_{A} value (I_{A}/I_{G}) of 0.00. Except for this, the same procedure as in Example 10 was taken to fabricate a test cell of Comparative Example 4.

### COMPARATIVE EXAMPLE 5

Comparative Example 5 used, as the carbon material, the same graphite particles as those used in Example 8 to fabricate a working electrode constituting the negative electrode, the graphite particles having the R value (I_{D}/I_{G}) of 0.32 and the R_{A} value (I_{A}/I_{G}) of 0.00. Except for this, the same procedure as in Example 10 was taken to fabricate a test cell of Comparative Example 5.

Likewise to the aforementioned test cells, the test cells of Examples 10-13 and Comparative Examples 4, 5 thus fabricated were each subjected to the lithium-ion insertion, which included: effecting conduction at a current density of 0.5 mA/cm² for inserting lithium ions from the counter electrode into the carbon material in the working electrode until the voltage of the working electrode was at 0.0V versus the counter electrode; effecting conduction at a current density of 0.25 mA/cm² for inserting lithium ions from the counter electrode into the carbon material in the working electrode until the voltage of the working electrode was at 0.0V versus the counter electrode; and effecting conduction at a current density of 0.1 mA/cm² for inserting lithium ions from the counter electrode into the carbon material in the working electrode until the voltage of the working electrode was at 0.0V versus the counter electrode.

As to the case where lithium ions were inserted into the carbon material of the working electrode of each test cell, the carbon material of each test cell was determined for the capacity Q1 (mAh/g). The results are listed in Table 3 as below.

Subsequently, each of the above test cells was subjected to the lithium ion de-insertion as follows. Conduction of a constant current at a current density of 0.25 mA/cm² was effected for de-inserting the lithium ions from the lithium-inserted carbon material until the voltage of the working electrode was at 1.0V versus the counter electrode.

As to the case where the lithium ions were de-inserted from the carbon material of the working electrode in each test cell, the capacity Q2 (mAh/g) of the carbon material of each test cell was determined. Furthermore, as the lithium-ion charge/discharge efficiency for the carbon material of each test cell, the ratio [(Q2/Q1)×100] of the capacity Q2 versus the capacity Q1 was determined. The results are listed in the following Table 3.

After the aforementioned de-insertion of the lithium ions from the carbon material, the impedance of each test cell was measured as superimposing an AC having a frequency of 20 kHz to 10 mHz and an amplitude of 10 mV so as to determine the reaction resistance (Ù·cm²) of each test cell. The results are listed in the following Table 3.

TABLE 3

| | | | | | CHARGE/ | |
|---|---|---|---|---|---|---|
| | | | | | DISCHARGE | REACTION |
| | R VALUE | R_{A} VALUE | Q1 | Q2 | EFFICIENCY | RESISTANCE |
| | (I_{D}/I_{G}) | (I_{A}/I_{G}) | (mAh/g) | (mAh/g) | (%) | (Ω · cm²) |
| EXAMPLE 10 | 0.40 | 0.16 | 378 | 356 | 94.2 | 40 |
| EXAMPLE 11 | 0.31 | 0.12 | 376 | 354 | 94.1 | 58 |
| EXAMPLE 12 | 0.62 | 0.26 | 367 | 345 | 94.0 | 86 |
| EXAMPLE 13 | 0.82 | 0.48 | 370 | 344 | 93.0 | 108 |
| COMPARATIVE EXAMPLE 4 | 0.18 | 0.00 | 375 | 354 | 94.7 | 120 |
| COMPARATIVE EXAMPLE 5 | 0.32 | 0.00 | 337 | 320 | 95.0 | 125 |

The following facts are apparent from the results. As to the case where the non-aqueous solvent of the non-aqueous electrolyte does not contain propylene carbonate, the test cells of Examples 10-13 using, in the negative electrode, the carbon materials having the R_{A} values (I_{A}/I_{G}) of 0.05 or more are more improved in the charge/discharge performances with reduced reaction resistance, as compared with the test cells of Comparative Examples 4, 5 employing the carbon materials having the R values (I_{D}/I_{G}) of less than 0.05. In the test cells of Examples 10-12 employing the carbon materials having the R_{A} values (I_{A}/I_{G}) in the range of 0.05 to 0.40 and the R values (I_{D}/I_{G}) in the range of 0.20 to 0.80, in particular, the reaction resistance is further reduced so that the charge/discharge performances are even further improved.

While the foregoing examples conducted the evaluation test using the aforementioned test cells, the same effects may be obtained by a common lithium cell using, in the positive electrode, a lithium-containing transition oxide such as lithium cobalt oxide LiCoO₂, lithium nickel oxide LiNiO₂ or lithium manganese oxide LiMn₂O₄. That is, the reaction resistance is reduced to permit lithium ions to be adequately inserted into or de-inserted from the carbon material used in the negative electrode and hence, the excellent charge/discharge performances may be achieved.

Although the present invention has been fully described by way of examples, it is to be noted that various changes and modifications will be apparent to those skilled in the art.

Therefore, unless otherwise such changes and modifications depart from the scope of the present invention, they should be construed as being included therein.

What is claimed is:

1. A lithium cell comprising a positive electrode, a negative electrode employing a carbon material as an active material, and a non-aqueous electrolyte comprising a solute dissolved in a non-aqueous solvent,
said negative electrode comprising a carbon material having an R_{A} value (I_{A}/I_{G}) of 0.05 or more, the R_{A} value calculated from a peak intensity (I_{A}) of a broad peak P_{A} having a full width at half maximum of 100 cm⁻¹ or more and a peak intensity (I_{G}) in the vicinity of 1580 cm⁻¹ as determined by laser Raman spectroscopy using an argon ion laser having a wavelength of 514.5 nm, the peak intensity (I_{A}) determined from a peak P_{D} in the vicinity of 1360 cm⁻¹, as determined by said laser Raman spectroscopy, which is separated into the broad peak P_{A} having the full width at half maximum of 100 cm⁻¹ or more and a peak P_{B} having a full width at half maximum of less than 100 cm^{-1.}

2. The lithium cell as claimed in claim 1, wherein said carbon material has said R_{A} value (I_{A}/I_{G}) in the range of 0.05 to 0.40.

3. The lithium cell as claimed in claim 1, wherein said carbon material has an R value (I_{D}/I_{G}) of 0.20 or more, the R value calculated from the peak intensity (I_{G}) in the vicinity of 1580 cm⁻¹ and a peak intensity (I_{D}) in the vicinity of 1360 cm⁻¹ as determined by said laser Raman spectroscopy.

4. The lithium cell as claimed in claim 3, wherein said carbon material has said R value (I_{D}/I_{G}) in the range of 0.20 to 0.80.

5. The lithium cell as claimed in claim 1, wherein vinylene carbonate is admixed to said non-aqueous electrolyte.

6. The lithium cell as claimed in claim 1, wherein a non-aqueous solvent containing 60 vol % or more of propylene carbonate is used in said non-aqueous electrolyte and wherein vinyl ethylene carbonate is admixed to said non-aqueous electrolyte.

7. The lithium cell as claimed in claim 6, wherein said carbon material has said R_{A} value (I_{A}/I_{G}) in the range of 0.05 to 0.25.

8. The lithium cell as claimed in claim 6, wherein said carbon material has an R value (I_{D}/I_{G}) of 0.20 or more, the R value calculated from the peak intensity (I_{G}) in the vicinity of 1580 cm⁻¹ and a peak intensity (I_{D}) in the vicinity of 1360 cm⁻¹ as determined by said laser Raman spectroscopy.

9. The lithium cell as claimed in claim 8, wherein said carbon material has said R value (I_{D}/I_{G}) in the range of 0.20 to 0.60.

10. The lithium cell as claimed in claim 6, wherein vinyl ethylene carbonate is admixed to said non-aqueous electrolyte in an amount of 0.1 to 10 parts by weight based on 100 parts by weight of the non-aqueous electrolyte.

11. The lithium cell as claimed in claim 6, wherein vinylene carbonate in addition to said vinyl ethylene carbonate, as additives, are admixed to said non-aqueous electrolyte.

12. The lithium cell as claimed in claim 11, wherein said additive mixture including vinyl ethylene carbonate and vinylene carbonate is admixed to said non-aqueous electrolyte in an amount of 0.1 to 13 parts by weight based on 100 parts by weight of said non-aqueous electrolyte.

13. A lithium cell comprising a positive electrode, a negative electrode employing a carbon material as an active material, and a non-aqueous electrolyte comprising a solute dissolved in a non-aqueous solvent containing 60 vol % or more of propylene carbonate,
wherein the carbon material in said negative electrode has an R value (I_{D}/I_{G}) of 0.20 or more, the R value calculated from a peak intensity (I_{G}) in the vicinity of 1580 cm⁻¹ and a peak intensity (I_{D}) in the vicinity of 1360 cm⁻¹ as determined by laser Raman spectroscopy using an argon ion laser having a wavelength of 514.5 nm, and
wherein vinyl ethylene carbonate is admixed to said non-aqueous electrolyte.

14. The lithium cell as claimed in claim 13, wherein vinyl ethylene carbonate is admixed to said non-aqueous electrolyte in an amount of 0.1 to 10 parts by weight based on 100 parts by weight of said non-aqueous electrolyte.

15. The lithium cell as claimed in claim 13, wherein vinylene carbonate in addition to said vinyl ethylene carbonate are admixed to said non-aqueous electrolyte.

16. The lithium cell as claimed in claim 15, wherein an additive mixture including vinyl ethylene carbonate and vinylene carbonate is admixed to said non-aqueous electrolyte in an amount of 0.1 to 13 parts by weight based on 100 parts by weight of said non-aqueous electrolyte.

17. The lithium cell as claimed in claim 13, wherein the carbon material in said negative electrode has an R value (I_{D}/I_{G}) in the range of 0.20 to 0.60.

18. The lithium cell as claimed in claim 13, wherein the carbon material in said negative electrode has an R_{A} value (I_{A}/I_{G}) in the range of 0.05 to 0.25, the R_{A} value calculated from a peak intensity (I_{A}) of a broad peak P_{A} having a full width at half maximum of 100 cm⁻¹ or more and a peak intensity (I_{G}) in the vicinity of 1580 cm⁻¹ as determined by laser Raman spectroscopy using an argon ion laser having a wavelength of 514.5 nm, the peak intensity (I_{A}) determined from a peak P_{D} in the vicinity of 1360 cm⁻¹ which is separated into the broad peak P_{A} having the full width at half maximum of 100 cm⁻¹ or more and a peak P_{B} having a full width at half maximum of less than 100 cm⁻¹.
